(19) United States
(12) Patent Application Publication
(10) Pub. No.: US 2013/0276819 A1
(43) Pub. Date: Oct. 24, 2013

(54) Dynamic chamber for cycle nucleation technology

(71) Applicant: ADVANCED WET TECHNOLOGIES GMBH, Huefingen (DE)

(72) Inventor: Richard W. Plavidal, Milpitas, CA (US)

(73) Assignee: Advanced Wet Technologies GmbH, Huefingen (DE)

(21) Appl. No.: 13/865,176

(22) Filed: Apr. 17, 2013

Related U.S. Application Data
(60) Provisional application No. 61/635,287, filed on Apr. 18, 2012.

(51) Int. Cl. B08B 3/12

(52) U.S. Cl. CPC B08B 3/12
USPC 134/1; 134/136; 134/105; 134/34

(57) ABSTRACT

A dynamic cyclic nucleation transport (D-CNX) process can be used to wet process an object, such as cleaning or etching. In the D-CNX process, the chamber volume is cyclically enlarged and reduced, effectively reducing and increasing the chamber pressure, respectively. During the pressure reduction phase, bubbles can be generated, which can be terminated or travel to the liquid surface during the pressure increment phase. The generation and termination of bubbles can clean or etch the object, even in hard to reach places.

This application claims priority from U.S. provisional patent application Ser. No. 61/635,287, filed on Apr. 18, 2012, entitled “Dynamic chamber for cycle nucleation technology”, which is incorporated herein by reference in its entirety.

### BACKGROUND

Parts or devices with complex shapes pose a special challenge for cleaning due to small openings, internal dead spaces, blind holes and other hard to access places within the part. Traditional sprays and sonic agitation cannot access these areas effectively and even if they could it would be difficult or impossible to remove loosened debris and contaminated cleaning solutions from these parts. Even complex manifold flow connections cannot effectively flush contamination from trapped areas and dead spaces within some parts.

### SUMMARY

In some embodiments, a dynamic cyclic nucleation transport (D-CNX) process is disclosed, including cyclically changing the volume of a process chamber, for example, through a piston or bellows. A D-CNX process and system can include a dynamic chamber volume that can instantly change from vacuum to pressure conditions and eliminates vacuum pumps. The potential benefits of the D-CNX process can include faster than using vacuum pumps to create pressure differences, no net evaporative cooling loss as a result of vapors being drawn from the solution and through the vacuum pump with every CNX cycle; chemistry mixture remains constant due to the fact that volatile components will be re-condensed with every CNX cycle rather than be removed through the vacuum pump; no vacuum pump is required, along with associated pipes, valves, surge tanks and isolation tanks; potentially flammable vapors (if present) are not concentrated and exposed to atmosphere through vacuum pumps; greater efficiency (<½ the power) due to the ability to recapture potential energy during the re-compression cycle; and continuous recycling and filtering of fluid through the process chamber with each CNX cycle.

### BRIEF DESCRIPTION OF THE DRAWINGS

FIGS. 1A-1C illustrate exemplary regimes of dynamic chamber operation according to some embodiments of the present invention.

FIGS. 2A-2B illustrate an exemplary dynamic chamber using bellows according to some embodiments of the present invention.

FIGS. 3A-3B illustrate an exemplary dynamic chamber using piston according to some embodiments of the present invention.

FIGS. 4A-4B illustrate another exemplary dynamic chamber using piston according to some embodiments of the present invention.

FIGS. 5A-5C illustrate another exemplary dynamic chamber using piston according to some embodiments of the present invention.

FIGS. 6A-6C illustrate various movement mechanisms for moving a piston according to some embodiments of the present invention.

FIGS. 7A-7D illustrate another exemplary dynamic chamber using piston according to some embodiments of the present invention.

FIG. 8 illustrates a CNX system according to some embodiments. An object 840 is submerged in a liquid 812 in a chamber.

FIGS. 9A-9C illustrate another exemplary dynamic chamber using piston according to some embodiments.

FIGS. 10A-10C illustrate another exemplary dynamic chamber using piston according to some embodiments.

FIG. 11 illustrates an exemplary flow chart for a cleaning process according to some embodiments.

### DETAILED DESCRIPTION

The development of Cycle Nucleation Transport (CNX) technology represented a breakthrough in addressing the aforementioned problem. With CNX it was possible to grow and collapse vapor bubbles in a vacuum environment which would displace fluids and dislodge contamination from hidden surfaces independent of boundary layers and geometries which would otherwise block any cleaning agitation or displacement. A key attribute of CNX is that all surfaces see the same pressure in a pressure controlled environment. Therefore, vapor bubbles will be created at any surface, whether hidden from direct view or not. As long as the pressure is held below the fluid vapor pressure, nucleation continues unabated and displacement currents continue to flow. Upon re-pressurization the vapor bubbles collapse and bring both fresh fluid and kinetic energy to the surface.

In some embodiments, the present invention discloses methods and apparatuses for cleaning and drying an object using cyclic CNX technology with a dynamic chamber concept. Dynamic chamber processing can significantly simplify the cleaning and drying equipment, for example, by eliminating vacuum pumps or power during the cyclic process. In addition, the consumables can be recoverable, for example, vapor byproducts from the dynamic chamber can be captured instead of released to the environment.

In some embodiments, the present invention discloses a dynamic chamber cyclic cleaning process, comprising cyclically changing the volume of a process chamber, for example, through a piston or bellows. In some embodiments, high temperatures, e.g., from a saturated or superheated liquid, can be used, which provides additional benefits of more efficient cleaning and cheaper liquid medium.

In some embodiments, the present invention discloses Dynamic Chamber CNX (D-CNX) process, which comprises a dynamic chamber volume that can instantly change from vacuum to pressure conditions and eliminates vacuum pumps. The potential benefits of the present D-CNX technology can include: D-CNX cycles 10-20 times faster than CNX using vacuum pumps and valves to create pressure differences; no net evaporative cooling loss as a result of vapors being drawn from the solution and through the vacuum pump with every CNX cycle; chemistry mixture remains constant due to the fact that volatile components will be re-condensed with every CNX cycle rather than be removed through the vacuum pump; no vacuum pump is required, along with associated pipes, valves, surge tanks and isolation tanks; potentially flammable vapors (if present) are not concentrated and exposed to atmosphere through vacuum pumps; greater efficiency (<½ the power) due to the ability to recapture potential energy during the re-compression cycle; and continuous recycling and filtering of fluid through the process chamber with each CNX cycle

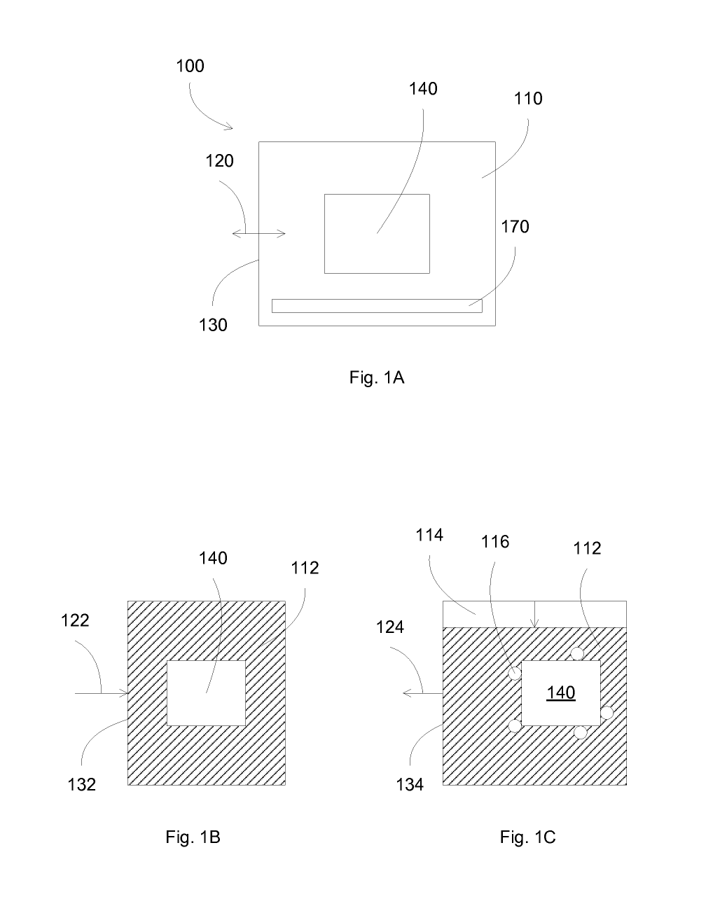

FIGS. 1A-1C illustrate exemplary regimes of dynamic chamber operation according to some embodiments of the present invention. In FIG. 1A, a dynamic chamber 100 comprises volume changing capability, such as having a movable wall 130. The dynamic chamber 100 can be filled with a liquid 110, with an object 140 submerged in the liquid. During the cyclic movements 120 of the wall 130, the pressure in the chamber 100 changes from high to low, terminating and generating bubbles at the object surfaces. For example, when the chamber wall 130 is extended, e.g., enlarging the volume of the chamber 100, vacuum is generated in the chamber, lowering the pressure and causing the liquid to boil. When the liquid boils, bubbles are generated. When the chamber wall 130 is contracted, e.g., reducing the volume of the chamber 100, the liquid is pressurized, causing the liquid to stop boiling. When the liquid stops boiling, bubbles are terminated, which can provide energy to the adhered particles, dislodging the particles from the object and releasing the particles to the liquid. An optional heater 170 can be included to heat the liquid, enlarging the process window, e.g., making the liquid boil and stop boiling with smaller change of pressure.

FIGS. 1B and 1C show the chamber volume reducing and enlarging, respectively. In FIG. 1B, force 122 is applied to the chamber wall, moving the chamber wall to position 132, reducing the volume of the chamber. For example, the volume is reduced so that there is no gaseous portion in the chamber, only the liquid portion 112. Under the high pressure, the liquid does not boil, and the bubbles are terminated. In FIG. 1C, force 124 is applied to the chamber wall, moving the chamber wall to position 134, enlarging the volume of the chamber. For example, the volume is enlarged to generate a vacuum portion 114 above the liquid portion 112. Under the low pressure, the liquid can start boiling, generating bubbles 116 on the surfaces of the object 140. The cyclic movements of the chamber wall can generate a cyclic nucleation and termination of the bubbles, cleaning the object surfaces.

The present dynamic chamber cycle nucleation technology can provide significant benefits, including simplifying equipment, expanded temperature ranges, e.g., higher temperatures are associated with faster reaction rates which increases part processing speed and cleaning effectiveness; greater use of pure water and steam at elevated temperatures to clean without the use of dangerous, expensive, or environmentally unfriendly chemicals; more efficient drying, which can be aided by the elevated temperatures as well as the ability for expanding vapor bubbles to rapidly displace trapped liquid on the surfaces of a part; elimination of vacuum pumps since pressure can be released to atmospheric pressure; usage of DI water, which at high temperature and pressure can offer superior cleaning and degreasing without solvents; simple design; and in-situ drying using saturated or superheated steam.

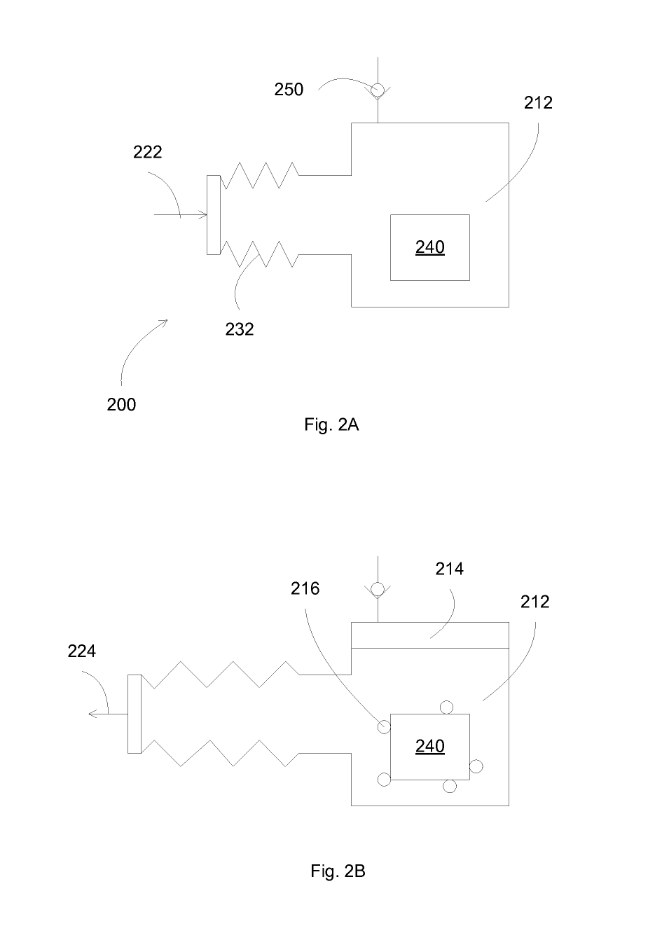

FIGS. 2A-2B illustrate an exemplary dynamic chamber using bellows according to some embodiments of the present invention. In FIG. 2A, an object 240 is submerged in a liquid 212 in a chamber 200. The container is preferably totally filled with the liquid 212, without any head space of vapor. A relief valve 250 can be connected to a top portion of the container, which can release any gaseous elements in the chamber 200. A bellows 232 is coupled to a chamber wall, which can move under a force to reduce or enlarge the volume of the chamber 200. As shown, a force 222 is pushing on the bellows, pressurizing the liquid, terminating any bubbles.

In some embodiments, the liquid comprises water, for example, water or water solutions with dissolved chemicals such as cleaning chemical. In some embodiments, the temperature of the water solutions can be above 100° C., such as between 100 and 200° C.

In FIG. 2B, a force 224 is pulling on the bellows, enlarging the volume of the chamber 200. Vacuum head space 214 appears on top of the liquid portion 212, together with bubbles 216 on the surfaces of the object 240, and also on the chamber surface.

When the volume of the chamber is reduced, for example, by pushing the bellows with force 222, the bubbles are terminated, cleaning the object surfaces.

The process can be repeated until the object is cleaned, or when it is no longer optimized, for example, then the liquid is filled with the particles released from the object surface. The liquid can be replaced with a fresh liquid, and the cyclic cleaning process can re-start.

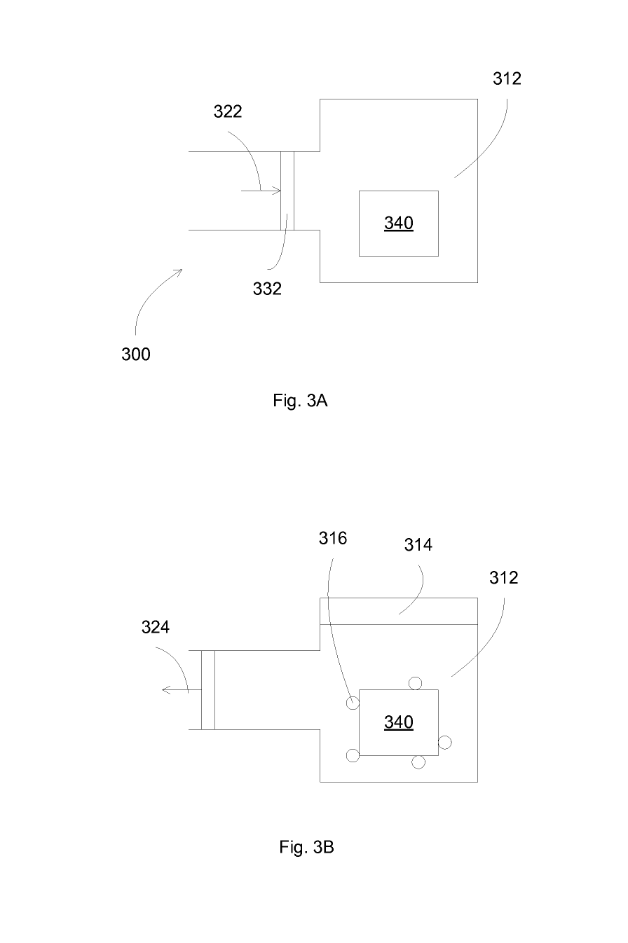

FIGS. 3A-3B illustrate an exemplary dynamic chamber using piston according to some embodiments of the present invention. In FIG. 3A, an object 340 is submerged in a liquid 312 in a chamber 300. The chamber is preferably totally filled with the liquid 312, without any head space of vapor. An optional relief valve can be connected to a top portion of the container, which can release any gaseous elements in the chamber. A piston 332 is coupled to a chamber wall, which can move under a force to reduce or enlarge the volume of the chamber. As shown, a force 322 is pushing on the piston, pressurizing the liquid, terminating any bubbles.

In FIG. 3B, a force 324 is pulling on the piston, enlarging the volume of the chamber. Vacuum head space 314 appears on top of the liquid portion 312, together with bubbles 316 on the surfaces of the object 340, and also on the chamber surface.

When the volume of the chamber is reduced, for example, by pushing the piston with force 322, the bubbles are terminated, cleaning the object surfaces.

The process can be repeated until the object is cleaned, or when it is no longer optimized, for example, then the liquid is filled with the particles released from the object surface.

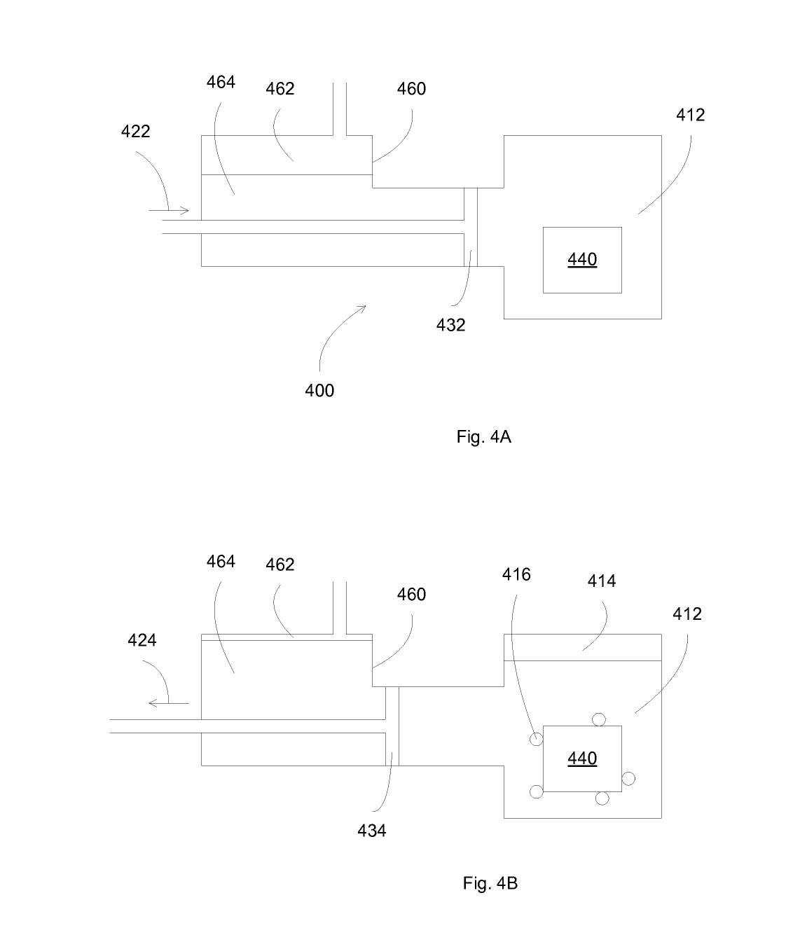

FIGS. 4A-4B illustrate another exemplary dynamic chamber using piston according to some embodiments of the present invention. In FIG. 4A, an object 440 is submerged in a liquid 412 in a chamber 400. The chamber is preferably totally filled with the liquid 412, without any head space of vapor. An optional relief valve can be connected to a top portion of the container, which can release any gaseous elements in the chamber. A piston 432 is coupled to a chamber wall, which can move under a force to reduce or enlarge the volume of the chamber. As shown, a force 422 is pushing on the piston, pressurizing the liquid, terminating any bubbles. A chamber 460 is coupled to the opposite side of the piston, containing liquid 464 with a head space 462 opened to atmosphere. The liquid 464 can reduce the potential leakage of liquid across the piston, since the liquid 464 can balance the liquid 412.

In FIG. 4B, a force 424 is pulling on the piston, enlarging the volume of the process chamber. Vacuum head space 414 appears on top of the liquid portion 412, together with bubbles 416 on the surfaces of the object 440, and also on the chamber surface. The liquid 464 rises in chamber 460, reducing the head space 462.

When the volume of the chamber is reduced, for example, by pushing the piston with force 422, the bubbles are terminated, cleaning the object surfaces.

The process can be repeated until the object is cleaned, or when it is no longer optimized, for example, then the liquid is filled with the particles released from the object surface.

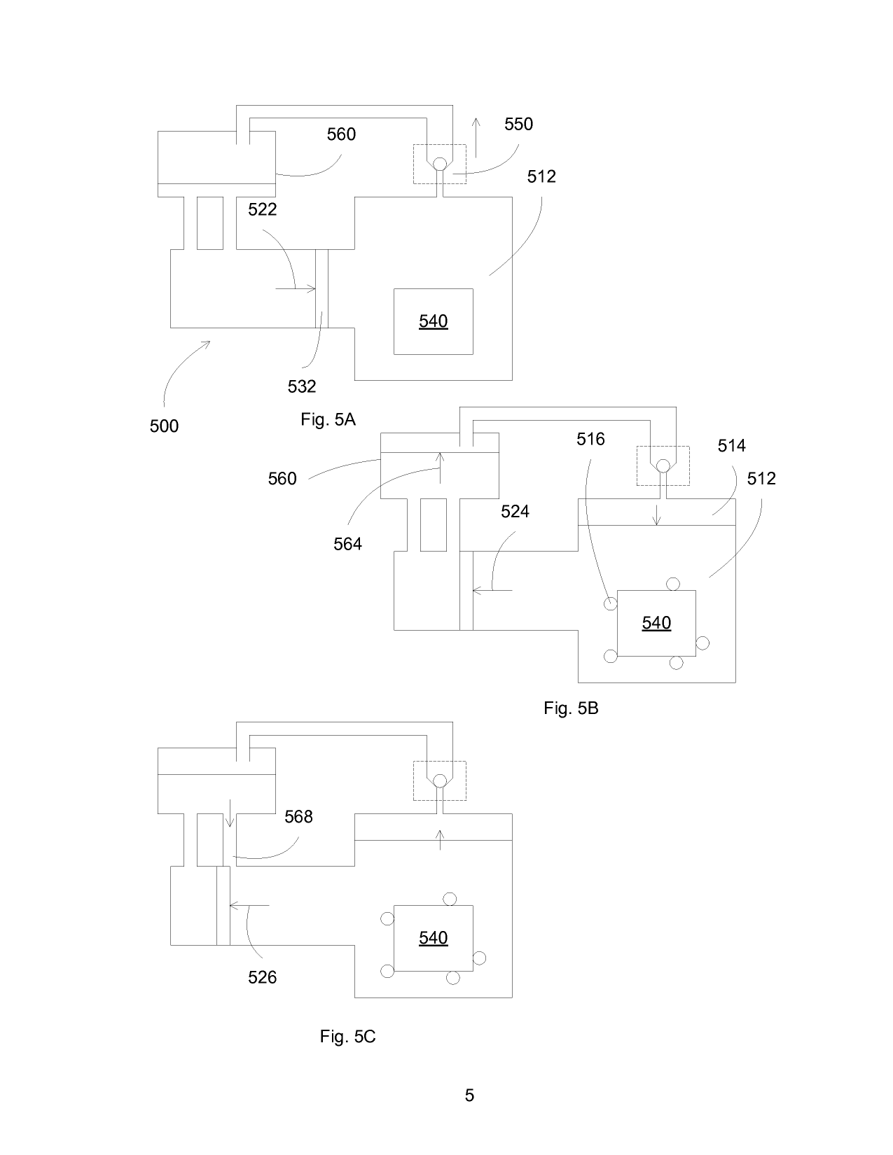

FIGS. 5A-5C illustrate another exemplary dynamic chamber using piston according to some embodiments of the present invention. In FIG. 5A, an object 540 is submerged in a liquid 512 in a chamber 500. The chamber is preferably totally filled with the liquid 512, without any head space of vapor. A relief valve, such as check valve 550, can be connected to a top portion of the container, which can release any excess liquid or gaseous elements in the chamber. A piston 532 is coupled to a chamber wall, which can move under a force to reduce or enlarge the volume of the chamber. As shown, a force 522 is pushing on the piston, pressurizing the liquid, terminating any bubbles. A chamber 560 is coupled to the opposite side of the piston, containing liquid with a head space coupled to the relief valve 550. The liquid can reduce the potential leakage of liquid across the piston, together with replenishing the liquid in the process chamber.

In FIG. 5B, a force 524 is pulling on the piston, enlarging the volume of the process chamber. Vacuum head space 514 appears on top of the liquid portion 512, together with bubbles 516 on the surfaces of the object 540, and also on the chamber surface. The liquid 564 rises in chamber 560.

In FIG. 5C, a force 526 is further pulling on the piston, passing a conduit 568 of the chamber 560, releasing some liquid from chamber 560 to the process chamber. The liquid in the chamber can increase, and thus during the pushing of the piston, excess liquid can return to the chamber 560.

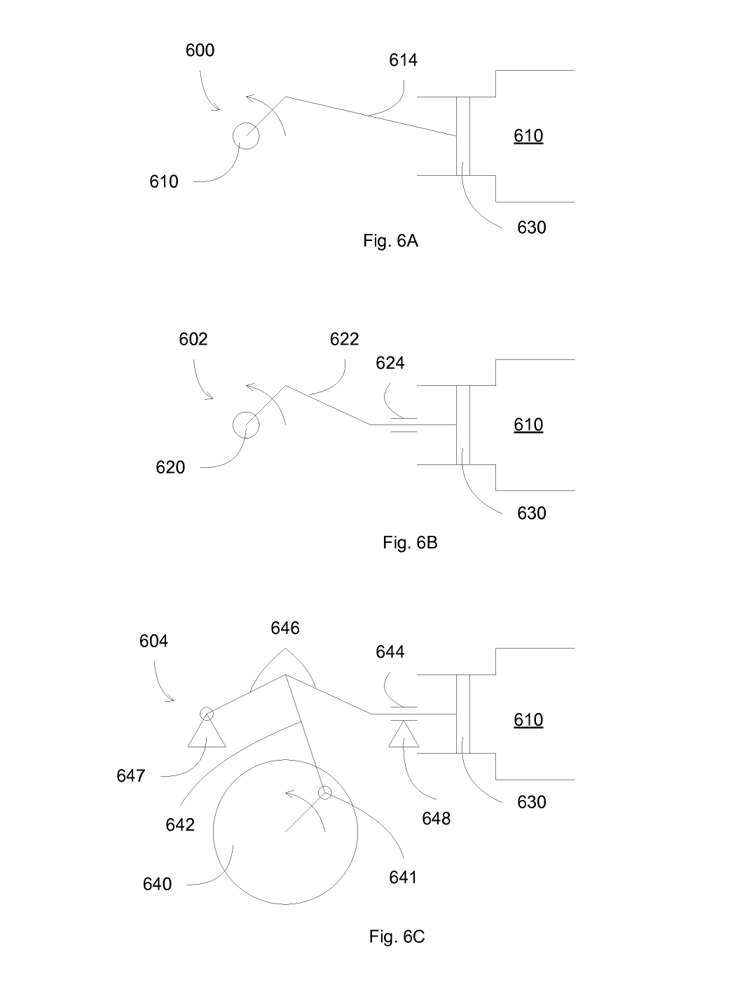

FIGS. 6A-6C illustrate various movement mechanisms for moving a piston according to some embodiments of the present invention. The mechanisms can be used for moving other components, such as moving a bellows or a chamber wall of the dynamic chamber. In FIG. 6A, a dynamic chamber 610 comprises a piston 630 for changing the volume. The piston 630 is coupled to a crank shaft system 600, which comprises a rotating motor drive 610, moving shaft 614. In FIG. 6B, a crank shaft system 602 comprises a rotating motor drive 620, moving shaft 622 which is coupled to a sliding bearing 624. In FIG. 6C, a scissor system 604 comprises a rotating motor drive 640, moving shaft 642 which is coupled to scissor arms 646. The scissor arms are coupled to a support 647 and a sliding bearing 644. The sliding bearing 644 is supported by support 648. A crank shaft 641 can be used to rotate the system 640. Other mechanisms can be used, such as linear drive motor, drive cylinders, pneumatic or hydraulic cylinders, and rotational reciprocation using crankshaft with connecting rod and flywheel.

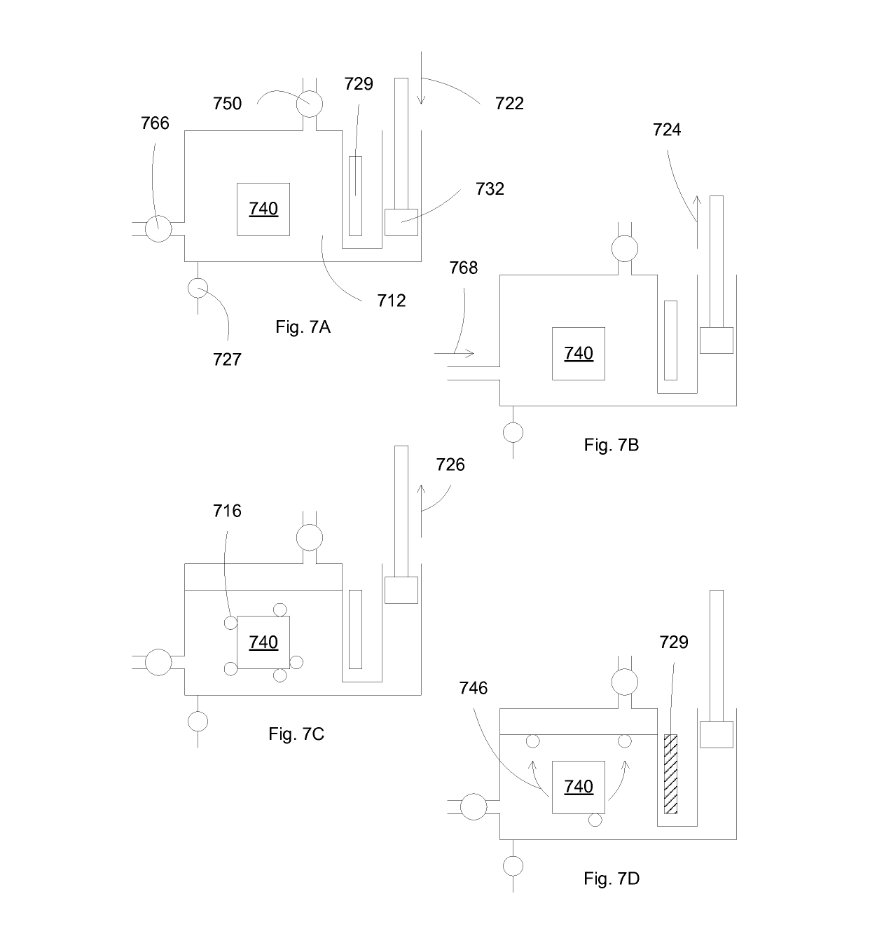

FIGS. 7A-7D illustrate another exemplary dynamic chamber using piston according to some embodiments of the present invention. In FIG. 7A, an object 740 is submerged in a liquid 712 in a chamber 700. The chamber is preferably totally filled with the liquid 712, without any head space of vapor. However, the chamber can be almost filled, with the piston retracted to enlarge the volume of the chamber. Thus when the piston is extended, e.g., reducing the chamber volume, the gaseous portion can be expelled, forming a totally filled chamber. A relief valve, such as check valve 750, can be connected to a top portion of the container, which can release any excess liquid or gaseous elements in the chamber. A piston 732 is coupled to a chamber wall, which can move under a force to reduce or enlarge the volume of the chamber. As shown, a force 722 is pushing on the piston, pressurizing the liquid, and optionally terminating any bubbles. The other end of the relief valve 750 can be coupled to a reservoir, which can be coupled to the opposite side of the piston. The liquid can reduce the potential leakage of liquid across the piston, together with replenishing the liquid in the process chamber. A conduit can be coupled to the chamber through a valve element 766. A drain valve 727 can be use to drain the liquid from the chamber.

An optional ultrasonic element 729 can couple to the chamber, for example, to provide excitation energy to the object 740. The power and frequency of the ultrasonic element can be low, for example, frequencies between 20 kHz to 400 kHz. The power and frequency of the ultrasonic element can be low enough not to generate any bobbles in the liquid or on the object. The ultrasonic element can be used for vibrating the object or the liquid surrounding the object, so that bubbles formed on the object can be detached.

In FIG. 7B, a force 724 is pulling on the piston, enlarging the volume of the process chamber. Valve 766 can be open, for example, either by actively opening the valve or be actuated by the pulling action of the piston. Liquid can flow to the chamber during the chamber volume enlargement.

In FIG. 7C, a force 726 is further pulling on the piston. The rate of liquid flow 768 can be less than the rate of chamber volume enlargement, thus vacuum head space can be formed. Vacuum head space can appear on top of the liquid portion, together with bubbles 716 on the surfaces of the object 740, and also on the chamber surface.

In FIG. 7D, the ultrasonic element can apply energy to the liquid and object, releasing 746 the bubbles to the vacuum head space. In some embodiments, the ultrasonic element can be turn on during the enlargement of the chamber volume, in assisting the release of the bubbles. In some embodiments, the ultrasonic element can be turn on at all times. Since the power and frequency of the ultrasonic element is low, there can be no damage to the object.

In some embodiments, the present invention discloses the use of a process fluid supply reservoir or reservoirs which can deliver temperature controlled liquid to the chamber.

In some embodiments, external excitation energy can be added to the process fluid, for example, to assist with the bubble termination or detachment from the object surface. For example, low power and low frequency ultrasonic system can be use in the CNX chamber. The power and frequency of the ultrasonic system can be low, since they are not designed to generate bubbles in the liquid. The ultrasonic system can be designed to agitate the liquid and/or the object, for example, to shake the bubbles that already formed during the low pressure cycle (or the volume expansion cycle). For example, the frequency of the ultrasonic can be less than 1 MHz, such as between 20 kHz and 400 kHz.

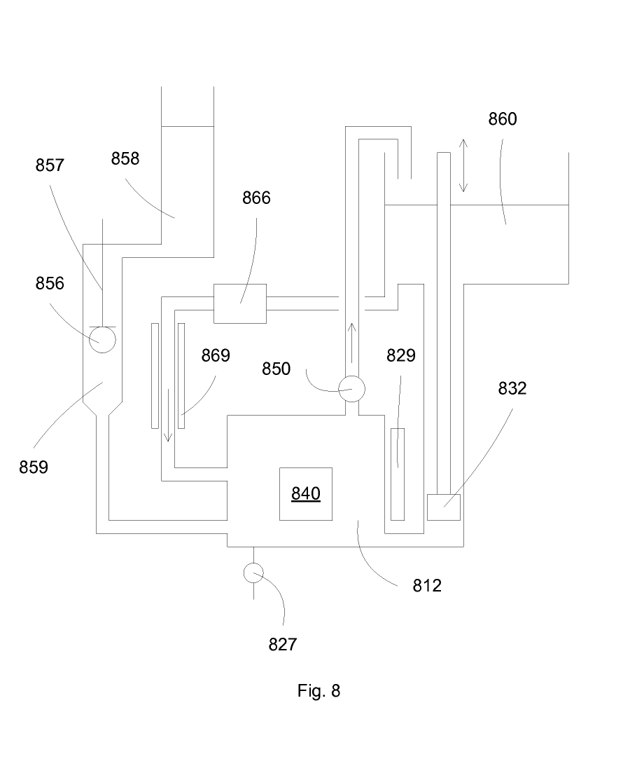

FIG. 8 illustrates a CNX system according to some embodiments. An object 840 is submerged in a liquid 812 in a chamber. The chamber can be filled with the liquid 812, without any head space of vapor. A relief valve, such as check valve 850, can be connected to a top portion of the chamber, which can release any excess liquid or gaseous elements in the chamber to the reservoir 860. A piston 832 is coupled to a chamber wall, which can move under a force to reduce or enlarge the volume of the chamber. The reservoir can be coupled to the opposite side of the piston. The liquid can reduce the potential leakage of liquid across the piston, together with replenishing the liquid in the process chamber. A conduit can be coupled to the chamber through a control element 866, which can control the amount of liquid flowing to the chamber during the volume expansion cycle. For example, a small size conduit, e.g., a quarter inch diameter line, can provide a much lower flow rate as compared to the chamber volume expansion rate exerted by the piston, e.g., a four inch diameter piston. A drain valve 827 can be use to drain the liquid from the chamber.

An optional heater 869 can be coupled to the liquid line, for example, to heat the liquid coming to the chamber. The heater and the heated liquid line can be configured to provide thermal energy to the object, and not to the chamber wall or to the piston. Since bubbles can be formed at high temperature fluid, heated object would generate bubbles for cleaning, instead of bubbles generated at the chamber wall.

An optional chemical delivery system can be used to add additional chemicals to the chamber. Metering element 859 can deliver proper amount of chemical liquid to the chamber per cycle. The amount can be determined by setting element 857. In some embodiments, chemical reservoir 858 can fill the metering element 859, which is set by setting element 857. During the volume expansion cycle, the chemical liquid is pulled from the meter element, until the ball 856 blocks the flow.

An optional ultrasonic element 829 can couple to the chamber, for example, to provide excitation energy to the object 840. The power and frequency of the ultrasonic element can be low, for example, frequencies between 20 kHz to 400 kHz. The power and frequency of the ultrasonic element can be low enough not to generate any bobbles in the liquid or on the object. The ultrasonic element can be used for vibrating the object or the liquid surrounding the object, so that bubbles formed on the object can be detached.

In some embodiments, an exemplary process can include the following steps. The process chamber, containing parts to be processed, is filled with a liquid. The dynamic chamber mechanism, e.g., the piston, begins to pressurize and depressurize the fluid in the process chamber. When the chamber volume is reduced, liquid is pressurized and excess liquid and/or gas byproducts are expelled through the pressure relief valve at the top portion of the chamber which can be set to a predetermined pressure. Expelled liquid can be returned to the fluid supply reservoir and gas byproducts can be vented away.

When the chamber volume is increased, pressure drops at or below the vapor pressure of one or more components in the process fluid—this begins the vapor nucleation cycle. If reaction gas byproducts are produced, this step also rapidly expands the gas bubbles as well, which adds to the displacement process. This mechanism is called “Gas Expansion Displacement” (GED). Before reducing the chamber volume again, a metered amount of process fluid at a controlled temperature can be added to the chamber. This supplies the continuous recycling of process fluid.

After the resupply fluid is added, the chamber volume is again reduced which re-pressurizes the chamber and fluid. This can collapse the vapor bubbles and shrink any remaining gas byproduct bubbles. The maximum pressure reached during this step can be controlled and limited by the pressure relief valve as in the step above. The pressure cycles created by the dynamic chamber volume mechanism continues until the process is complete. The process chamber then can be drained of process fluid.

The above steps may be repeated with other process fluids as required by the processing sequence. Finally, after the final drain, a dry step may be added which introduces temperature controlled gas or air into the chamber to assist in drying the part(s). Upon completion, processed part(s) may be unloaded from the process chamber.

In some embodiments, the present invention discloses the use of a process fluid filled chamber equipped with a mechanical mechanism which can rapidly change the volume of the chamber. The chamber is designed to be completely filled with process fluid leaving no voids for trapped gas. This is referred to as zero head space. The chamber can also withstand pressure changes from vacuum to 2 or more atmospheres. The chamber can have one or more doors allowing parts to be placed inside. The chamber can be able to change volume 1-15% or more by a mechanically controlled device at a rate of 1-10 times per second or more. (Total volume change times frequency should approximately equal 10-100% chamber volume every second). Dynamic mechanism can have sub-sonic velocity and be placed low in the chamber and/or kept cooler than the chamber operating chamber, e.g., forming cold piston and not heating the piston, to prevent cavitation at the moving surface. The chamber can be able to drain completely. The chamber can exhaust excess fluid and non-condensable gas byproducts through a pressure relief valve at the top of the chamber. The chamber can introduce fresh fluid back into the chamber as required.

In some embodiments, the present invention discloses the use of one or more process fluid reservoirs, each capable of delivering process fluid to the process chamber at a specified temperature. Temperature control may be accomplished by the use of an on-board inline heat exchanger with in-line filtration if necessary. The bulk of the fluid in the reservoir may also be chilled to allow condensing of any volatile components as they are returned to the reservoir from the process chamber.

In some embodiments, the present invention discloses a mechanical mechanism for dynamically changing chamber volume, which can comprise one or more of the following features: piston and cylinder with process fluid seal, bellows system—no seal required, linear activation drive mechanism with scissor mechanism with drive cylinder actuator, direct pneumatic cylinder (single or dual action), direct hydraulic cylinder (single or dual action), linear drive motor, crankshaft and connecting rod with rotating motor drive. The dynamic chamber can also comprise potential energy recovery to conserve energy: Spring, pneumatic, or kinetic energy system (e.g. flywheel) to capture potential energy and reduce forces required by energy source to move piston or bellows.

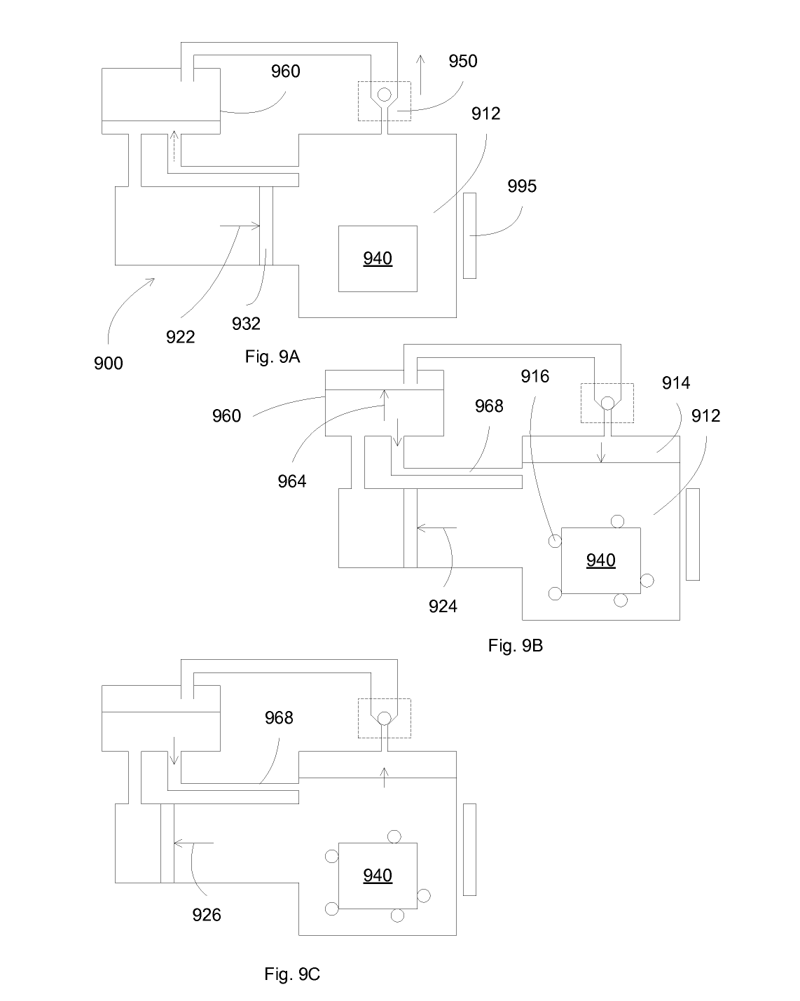

FIGS. 9A-9C illustrate another exemplary dynamic chamber using piston according to some embodiments. In FIG. 9A, an object 940 is submerged in a liquid 912 in a chamber 900. The chamber is preferably totally filled with the liquid 912, without any head space of vapor. A relief valve, such as check valve 950, can be connected to a top portion of the container, which can release any excess liquid or gaseous elements in the chamber. A piston 932 is coupled to a chamber wall, which can move under a force to reduce or enlarge the volume of the chamber. As shown, a force 922 is pushing on the piston, pressurizing the liquid, terminating any bubbles. A chamber 960 is coupled to the opposite side of the piston, containing liquid with a head space coupled to the relief valve 950. The liquid can reduce the potential leakage of liquid across the piston, together with replenishing the liquid in the process chamber.

An optional ultrasonic element 929 can couple to the chamber, for example, to provide excitation energy to the object 940. The power and frequency of the ultrasonic element can be low, for example, frequencies between 20 kHz to 400 kHz. The power and frequency of the ultrasonic element can be low enough not to generate any bobbles in the liquid or on the object. The ultrasonic element can be used for vibrating the object or the liquid surrounding the object, so that bubbles formed on the object can be detached.

In FIG. 9B, a force 924 is pulling on the piston, enlarging the volume of the process chamber. Vacuum head space 914 appears on top of the liquid portion 912, together with bubbles 916 on the surfaces of the object 940, and also on the chamber surface. The liquid 964 rises in chamber 960. Some liquid can flow from chamber 960 to the process chamber 900. The flow through the conduit 968 can be configured to be much less than the volume enlargement, thus vacuum head space 914 can appear. The flow 968 can be configured to deliver the liquid to the chamber, for example, to a vicinity of the object. An optional heater (not shown) can be coupled to the conduit to heat the liquid flow in the conduit 968 before reaching the chamber 900.

In FIG. 9C, a force 926 continues pulling on the piston. The resulting reduced pressure in the chamber 900 draws in liquid from the chamber 960 through a restricted conduit 968. This liquid provides the recirculation of liquid between chamber 900 and chamber 960.

In some embodiments, an additional chemistry may be drawn into the process chamber during each low pressure or volume expansion cycle. The chemical may be one that reacts with either the bulk process fluid or with the object or part that is being treated in the chamber. The excess volume that is metered into the chamber during each expansion cycle will cause excess liquid or liquid and gas to be expelled through the pressure relief valve during the compression cycle. Metering a reactive chemistry into the chamber has a number of key benefits:

1. Allows controlled entry of highly reactive chemicals which either could not be pre-mixed in bulk quantity,

2. Provides efficient use of chemical reactions—especially for chemical mixes that self-react and decay over time,

3. Many of the reactive chemicals will cause gas byproducts which produce a mechanism of GED, which can be a very effective transport mechanism as gas bubbles grow and shrink with changing volume and pressure.

Some examples of metering chemistry applications include adding KOH into a hydrogen peroxide solution to aid in bioburden removal in medical device cleaning. The resulting exothermic reaction would be difficult to manage if mixed together in bulk. Hydrogen peroxide and sulfuric acid can produce a reactive and short lived bath called “Piranha etch” that would be longer lasting and more efficient in an injection CNX chamber.

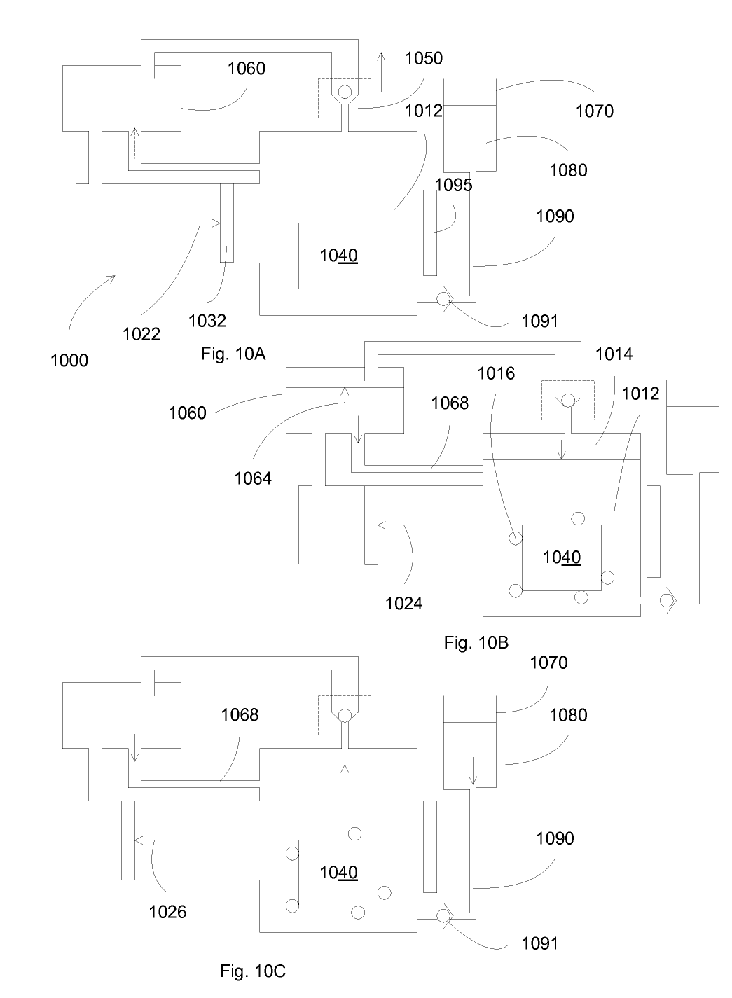

FIGS. 10A-10C illustrate another exemplary dynamic chamber using piston according to some embodiments. In FIG. 10A, an object 1040 is submerged in a liquid 1012 in a chamber 1000. The chamber is preferably totally filled with the liquid 1012, without any head space of vapor. A relief valve, such as check valve 1050, can be connected to a top portion of the container, which can release any excess liquid or gaseous elements in the chamber. A piston 1032 is coupled to a chamber wall, which can move under a force to reduce or enlarge the volume of the chamber. As shown, a force 1022 is pushing on the piston, pressurizing the liquid, terminating any bubbles. A chamber 1060 is coupled to the opposite side of the piston, containing liquid with a head space coupled to the relief valve 1050. The liquid can reduce the potential leakage of liquid across the piston, together with replenishing the liquid in the process chamber.

A chemical reservoir 1070 containing chemical 1080 can be added to the chamber 1000 through check valve 1091.

An optional ultrasonic element 1029 can couple to the chamber, for example, to provide excitation energy to the object 1040. The power and frequency of the ultrasonic element can be low, for example, frequencies between 20 kHz to 400 kHz. The power and frequency of the ultrasonic element can be low enough not to generate any bobbles in the liquid or on the object. The ultrasonic element can be used for vibrating the object or the liquid surrounding the object, so that bubbles formed on the object can be detached.

In FIG. 10B, a force 1024 is pulling on the piston, enlarging the volume of the process chamber. Vacuum head space 1014 appears on top of the liquid portion 1012, together with bubbles 1016 on the surfaces of the object 1040, and also on the chamber surface. The liquid 1064 rises in chamber 1060. Some liquid can flow from chamber 1060 to the process chamber 1000. The flow through the conduit 1068 can be configured to be much less than the volume enlargement, thus vacuum head space 1014 can appear. The flow in conduit 1068 can be configured to deliver the liquid to the chamber, for example, to a vicinity of the object. An optional heater can be coupled to the conduit to heat the liquid flow 1068 before reaching the chamber 1000.

In FIG. 10C, a force 1026 continues pulling on the piston. The resulting reduced pressure in the system draws in recirculating liquid through conduit 1068, and it also brings chemical liquid 1080, stored in chamber 1070, through a restricted conduit 1090. A check valve 1091 can ensure no reverse flow during piston compressive cycle per FIG. 10A.

In some embodiments, the present invention discloses the use of a process fluid supply reservoir or reservoirs delivers temperature-controlled liquid to the process chamber. In some embodiments, an exemplary process can include the following steps. The process chamber, containing parts to be processed, is filled completely with a liquid. The dynamic chamber mechanism begins to pressurize and depressurize the fluid in the process chamber. When the chamber volume is reduced, liquid is pressurized and excess liquid and/or gas byproducts are expelled through the pressure relief valve at the top of the chamber which is set to a pre-determined pressure. Expelled liquid is returned to the fluid supply reservoir and gas byproducts are vented away. When the chamber volume is increased, pressure drops at or below the vapor pressure of one or more components in the process fluid—this begins the vapor nucleation cycle. If reaction gas byproducts are produced, this step also rapidly expands the gas bubbles as well, which adds to the displacement process. Before reducing the chamber volume again, a metered amount of process fluid at a controlled temperature can be added to the chamber. This supplies the continuous recycling of process fluid. After the resupply fluid is added, the chamber volume is again reduced which re-pressurizes the chamber and fluid. This collapses the vapor bubbles and shrinks any remaining gas byproduct bubbles. The maximum pressure reached during this step can be controlled and limited by the pressure relief valve as in the step above. The pressure cycles created by the dynamic chamber volume mechanism continues until the process is complete. The process chamber is drained of process fluid.

The above steps may be repeated with other process fluids as required by the processing sequence. Finally, after the final drain, a dry step may be added which introduces temperature controlled gas or air into the chamber to assist in drying the part(s). Upon completion, processed part(s) may be unloaded from the process chamber.

In some embodiments, the present invention discloses the use of a process fluid filled chamber equipped with a mechanical mechanism which can rapidly change the volume of the chamber. The chamber is designed to be completely filled with process fluid leaving no voids for trapped gas. This is referred to as zero head space. The chamber can also withstand pressure changes from vacuum to 2 or more atmospheres. The chamber can have one or more doors allowing parts to be placed inside. The chamber can be able to change volume 1˜15% or more by a mechanically controlled device at a rate of 1˜10 times per second or more. (Total volume change times frequency should approximately equal 50˜100% chamber volume every second). Dynamic mechanism can have sub-sonic velocity and be placed low in the chamber to prevent cavitation at the moving surface. The chamber can be able to drain completely. The chamber can exhaust excess fluid and non-condensable gas byproducts through a pressure relief valve at the top of the chamber. The chamber can introduce fresh process fluid back into the chamber as required

In some embodiments, the present invention discloses the use of one or more process fluid reservoirs, each capable of delivering process fluid to the process chamber at a specified temperature. Temperature control may be accomplished by the use of an in-line heat exchanger with in-line filtration if necessary. The bulk of the fluid in the reservoir may also be chilled to allow condensing of any volatile components as they are returned to the reservoir from the process chamber.

In some embodiments, the present invention discloses a mechanical mechanism for dynamically changing chamber volume, which can comprise one or more of the following features: piston and cylinder with process fluid seal, bellows system—no seal required, linear activation drive mechanism with scissor mechanism with drive cylinder actuator, direct pneumatic cylinder (single or dual action), direct hydraulic cylinder (single or dual action), linear drive motor, crankshaft and connecting rod with rotating motor drive. The dynamic chamber can also comprise potential energy recovery to conserve energy: Spring, pneumatic, or kinetic energy system (e.g. flywheel) to capture potential energy and reduce forces required by energy source to move piston or bellows.

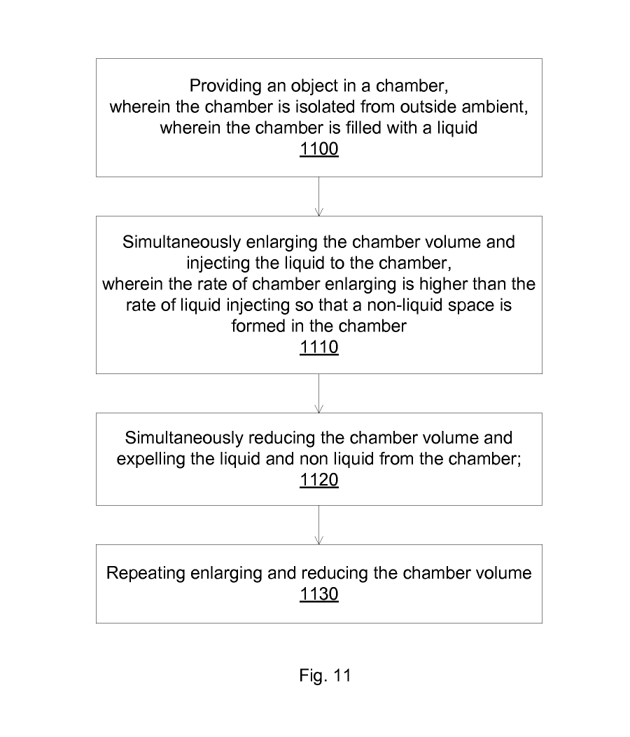

FIG. 11 illustrates an exemplary flow chart for a cleaning process according to some embodiments. Operation 1100 provides an object in a chamber, wherein the chamber is isolated from outside ambient, wherein the chamber is filled with a liquid. Operation 1110 simultaneously enlarges the chamber volume and injects the liquid to the chamber, wherein the rate of chamber enlarging is higher than the rate of liquid injecting so that a non-liquid space is formed in the chamber. Operation 1120 simultaneously reduces the chamber volume and expels the liquid and non liquid from the chamber. Operation 1130 repeats enlarging and reducing the chamber volume.

In some embodiments, the injected liquid can be less than 40% of the chamber enlargement. The chamber volume can be reduced to the chamber volume before being enlarged. The liquid can be heated before being injected to the chamber. An ultrasonic power can be applied to the liquid during the chamber volume enlargement. The power of the ultrasonic power can be less than an exited power to generate bubbles in the liquid. The frequency of the ultrasonic power can be less than an exited frequency to generate bubbles in the liquid. Further, a second liquid can be simultaneously injected to the chamber during the chamber volume enlargement, wherein the rate of chamber enlarging is higher than the total rates of liquid injecting. The second liquid can be heated before being injected to the chamber. The second liquid can be metered before being injected to the chamber.

What is claimed is:

1. A system comprising
a chamber,
wherein the chamber is configured to hold a first liquid,
wherein the chamber comprises an opening,
wherein the chamber comprises a door mated to the opening,
wherein the chamber comprises an outlet coupled to a first portion of the chamber,
wherein the chamber comprises an inlet coupled to a second portion of the chamber;
a check valve couple to the outlet;
a reservoir,
wherein the reservoir is configured to hold the first liquid,
wherein the reservoir configured to couple to the chamber through a conduit coupled to the inlet;
a piston coupled to the chamber volume,
wherein one first side of the piston is coupled to the chamber volume,
wherein one second side of the piston is coupled to the reservoir,
wherein the movement of the piston is configured to enlarge or reduce the volume of the chamber,
wherein the area of the conduit is configured so that the rate of flow through the conduit is less than the rate of the chamber volume is enlarged due to the movement of the piston.

2. A system as in claim 1 wherein the liquid flowed through the conduit is less than 40% of the chamber enlargement.

3. A system as in claim 1 wherein the check valve is coupled to the reservoir.

4. A system as in claim 1 further comprising
a heater coupled to the first liquid to heat the first liquid before flowing to the chamber.

5. A system as in claim 1 further comprising
an ultrasonic assembly coupled to the chamber to deliver ultrasonic power to the liquid.

6. A system as in claim 6 wherein the power of the ultrasonic power is less than an exited power to generate bubbles in the liquid.

7. A system as in claim 6 wherein the frequency of the ultrasonic power is less than an exited frequency to generate bubbles in the liquid.

8. A system as in claim 1 further comprising
a second reservoir configured to hold a second liquid,
wherein the second reservoir is configured to couple to the chamber through a metering device coupled to the inlet;

9. A system as in claim 8 further comprising
a heater coupled to the second liquid to heat the second liquid before flowing to the chamber.

10. A system comprising
a chamber,
wherein the chamber is configured to hold a first liquid,
wherein the chamber comprises an opening,
wherein the chamber comprises a door mated to the opening,
wherein the chamber comprises an outlet coupled to a first portion of the chamber,
wherein the chamber comprises an inlet coupled to a second portion of the chamber;
a check valve couple to the outlet;
a reservoir,
wherein the reservoir is configured to hold a second liquid,
wherein the reservoir is configured to couple to the chamber through a metering device coupled to the inlet;
a piston,
wherein one first side of the piston is coupled to the chamber volume,
wherein the movement of the piston is configured to enlarge or reduce the volume of the chamber,
wherein the area of the conduit is configured so that the rate of flow through the conduit is less than the rate of the chamber volume is enlarged due to the movement of the piston.

11. A method comprising
providing an object in a chamber,
wherein the chamber is isolated from outside ambient,
wherein the chamber is filled with a liquid;
simultaneously enlarging the chamber volume and injecting the liquid to the chamber,
wherein the rate of chamber enlarging is higher than the rate of liquid injecting so that a non-liquid space is formed in the chamber;
simultaneously reducing the chamber volume and expelling the liquid and non liquid from the chamber;
repeating enlarging and reducing the chamber volume.

12. A method as in claim 11 wherein the injected liquid is less than 40% of the chamber enlargement.

13. A method as in claim 11 wherein the chamber volume is reduced to the chamber volume before being enlarged.

14. A method as in claim 11 further comprising
heating the liquid before injecting to the chamber.

15. A method as in claim 11 further comprising
applying an ultrasonic power to the liquid during the chamber volume enlargement.

16. A method as in claim 15 wherein the power of the ultrasonic power is less than an exited power to generate bubbles in the liquid.

17. A method as in claim 15 wherein the frequency of the ultrasonic power is less than an exited frequency to generate bubbles in the liquid.

18. A method as in claim 11 further comprising
simultaneously injecting a second liquid to the chamber during the chamber volume enlargement,
wherein the rate of chamber enlarging is higher than the total rates of liquid injecting.

19. A method as in claim 18 further comprising
heating the second liquid before injecting to the chamber.

20. A method as in claim 18 further comprising
metering the second liquid before injecting to the chamber.
